(19) United States
(12) Patent Application Publication
(10) Pub. No.: US 2019/0323214 A1
(43) Pub. Date: Oct. 24, 2019

(54) SHOWER DEVICE HAVING SHOWER HEAD FIXING STRUCTURE

(71) Applicant: Runner (Xiamen) Corp., Xiamen (CN)

(72) Inventors: YUYAN WANG, Xiamen (CN); WEN GAO, Xiamen (CN)

(21) Appl. No.: 16/385,296

(22) Filed: Apr. 16, 2019

(30) Foreign Application Priority Data
Apr. 18, 2018 (CN) 201820552089.6

(51) Int. Cl. E03C 1/04; B05B 1/18; E03C 1/06

(52) U.S. Cl. CPC E03C 1/0409; E03C 2001/0415; E03C 1/06; B05B 1/185

(57) ABSTRACT

A shower device, that includes a shower head fixing structure for fixing a shower head to a water passing member, a water inlet arm, and a hose. The shower head fixing structure includes a fixing male member and a fixing female member. As such, the shower device includes a shower head, a water passing member, a fixing male member, a fixing female member, a water inlet arm, and a hose. The shower head can be detachably connected to the water passing member via the fixing female member and the fixing male member.

### BACKGROUND OF THE INVENTION

### Field of the Invention

The present invention relates to a shower device, particularly to a shower device having a shower head fixing structure, that can be used to fix a shower head to a water passing member.

### Description of the Prior Art

As well known to those skilled in the art, traditional shower devices can be divided into three types. One is a completely fixed shower head. The shower head is generally fixedly connected to the water inlet arm and cannot be disassembled at any time. This type of shower head is used in public areas, such as a school bathhouse. Since the shower head is completely fixed, it is not convenient to use. Since the shower head is completely fixed, it is not convenient to use. Another type possesses a fixed shower head and a hand shower. This type is to switch the water paths through the switching spool so that the water flows out from the shower head and the hand shower respectively or simultaneously. Although the shower device can meet the user's needs for fixing and hand-held, the production cost is relatively high. The third type is that a hand shower is not completely fixed, and the hand shower is fixed at a certain position when a fixed water flow is required; when the special position needs to be flushed, the hand shower is taken down for use. The third type of shower device is more widely used because of its good using experience and low production cost.

Where the shower head in the third type of shower device is fixed, the handle of the shower head is fixed in the fixed seat by adding a fixing seat. However, the dimension of the fixed seat needs to match the handle of the shower head, and the handle of the traditional shower head is usually ergonomically designed, and the shape is relatively elegant, which makes the shape of the fixed seat complex. Therefore, it is necessary to improve the traditional shower head fixing structure.

### SUMMARY OF THE INVENTION

An objective of the present invention is to solve the above-mentioned problems and to provide a shower device, that includes a shower head fixing structure for fixing a shower head to a water passing member, a water inlet arm, and a hose. The shower head fixing structure includes a fixing male member and a fixing female member. As such, the shower device includes a shower head, a water passing member, a fixing male member, a fixing female member, a water inlet arm, and a hose. The shower head can be detachably connected to the water passing member via the fixing female member and the fixing male member.

In the shower device, the water flows into the water passing member through the water inlet arm, flows through the water passing member, and then flows into the shower through the hose.

In the embodiments of the present invention, one end of the water inlet arm is connected to the water passing member. One end of the hose is connected to the water passing member, and the other end of the hose is connected to the shower head.

In the embodiments of the present invention, the water passing member includes a first water inlet and a first water outlet. The first water inlet is connected to one end of the water inlet arm, and the first water outlet is connected to the hose.

In the embodiments of the present invention, the first water inlet is provided with a thread, and the first water outlet is provided with a thread. The first water inlet is connected to the water inlet arm with the thread, and the first water outlet is connected to the hose with the thread.

In the embodiments of the present invention, one end of the shower head is provided with a second water inlet, and the second water inlet is connected to the hose.

In the embodiments of the present invention, the second water outlet is provided with a thread, and the second water inlet is connected to the hose with the thread.

In the embodiments of the present invention, the shower head fixing structure includes a fixing male member and a fixing female member. The fixing male member is disposed at one end of the water passing member. The fixing female member is disposed on a side opposite to the water outlet side of the shower head, and a fixing opening for receiving the fixing male member is formed between the fixing female member and the shower head.

In the embodiments of the present invention, the fixing male member is integrally formed with the water passing member, or the fixing male member is attached to one end of the water passing member.

In the embodiments of the present invention, the fixing female member is integrally formed with the shower head, or the fixing female member is attached to an upper portion of the backside of the shower head. The fixing opening is disposed on the shower head. The fixing female member includes a fixing portion, and the fixing portion is disposed in the fixing opening of the shower head.

In the embodiments of the present invention, the fixing male member is a circular plate.

In the embodiments of the present invention, one side of the fixing male member in contact with the shower head is a flat surface. An edge of the fixing male member is convex for linking with the fixing female member.

In the embodiments of the present invention, one end surface of the fixing female member is semicircular.

In the embodiments of the present invention, the outlet of the shower head is front, then the opposite part is the backside. The fixing female member is disposed on an upper portion of the backside of the shower head.

In the embodiments of the present invention, the fixing opening is disposed on the fixing female member, and the fixing opening is semicircular. The fixing opening is fitted to the end surface of the water passing member.

Compared with the traditional shower head fixing structures, the present invention has several advantages. First, the embodiments enable a shower head fixing structure by using simple structure. The shower head fixing structure is easy to manufacture and manufacture at low cost. Second, the contact area between the fixing female member and the fixing male member of the present invention is large, so the shower head can be stably fixed. Finally, a shower device of the present invention has the head fixing structure, so that it is not necessary to add a special fixing seat, which can reduce the production cost.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a perspective view of a shower head fixing structure of the present invention.

FIG. 2 is a perspective view of a shower device having the shower head fixing structure of FIG.1 of the present invention.

### DETAILED DESCRIPTION OF THE PREFERRED EMBODIMENTS

### Embodyment 1

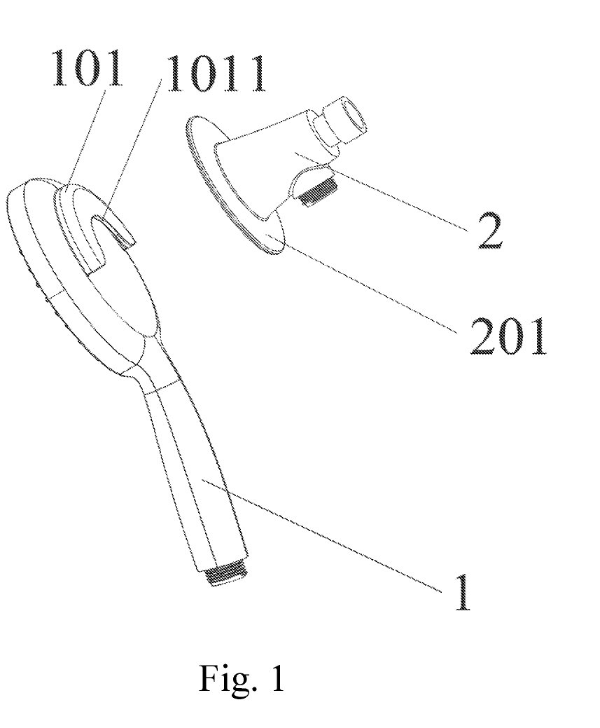

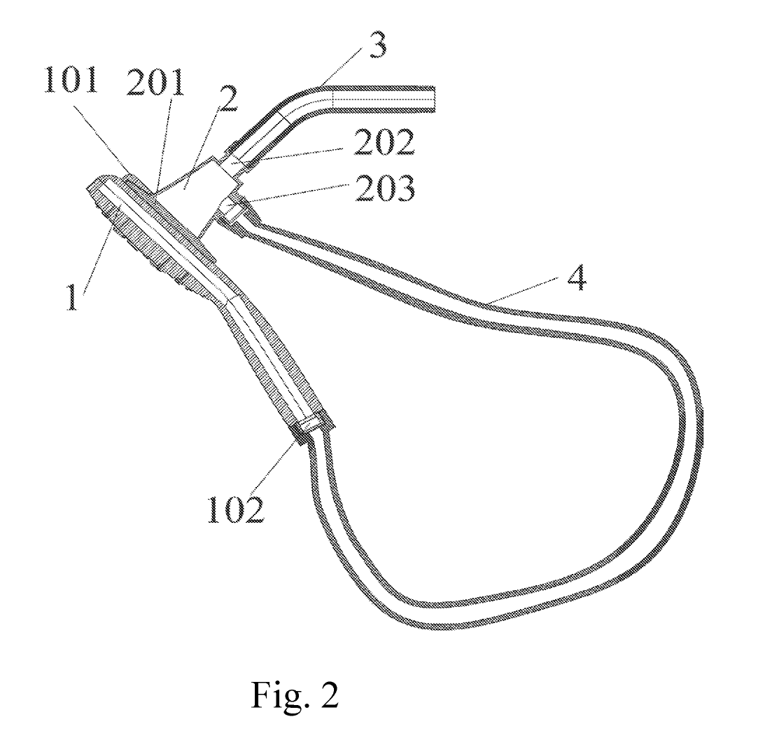

As shown in FIGS. 1 and 2, the present invention provides a shower device, that includes shower head fixing structure for fixing a shower head 1 to a water passing member 2, a water inlet arm 3, and a hose 4. The shower head fixing structure includes a fixing male member 201 and a fixing female member 101. The fixing male member 201 is disposed at one end of the water passing member 2. The fixing female member 101 is disposed on a side opposite to the water outlet side of the shower head 1, and a fixing opening 1011 for receiving the fixing male member 201 is formed between the fixing female member 101 and the shower head 1.

And, the fixing male member 201 is integrally formed with the water passing member 2.

Then, the fixing female member 101 is integrally formed with the shower head 1.

Next, the fixing male member 201 is a circular plate.

Next, one side of the fixing male member 201 in contact with the shower head 1 is a flat surface. An edge of the fixing male member 201 is convex for linking with the fixing female member 101.

Next, one end surface of the fixing female member 101 is semicircular.

Next, the outlet of the shower head 1 is front, then the opposite part is the backside. The fixing female member 101 is disposed on an upper portion of the backside of the shower head 1.

Next, the fixing opening 1011 is disposed on the fixing female member 101, and the fixing opening 1011 is semicircular. The fixing opening 1011 is fitted to the end surface of the water passing member 2.

The present invention-provides a shower device that includes a shower head 1, a water passing member 2, a water inlet arm 3, a hose 4, a fixing female member 101, and a fixing male member 201. One end of the water inlet arm 3 is connected to the water passing member 2. One end of the hose 4 is connected to the water passing member 2, and the other end of the hose 4 is connected to the shower head 1.

And, the water passing member 2 includes a first water inlet 202 and a first water outlet 203. The first water inlet 202 is connected to one end of the water inlet arm 3, and the first water outlet 203 is connected to the hose 4.

Then, the first water inlet 202 is provided with a thread, and the first water outlet 203 is provided with a thread. The first water inlet 202 is connected to the water inlet arm 3 with the thread, and the first water outlet 203 is connected to the hose 4 with the thread.

Next, one end of the shower head 1 is provided with a second water inlet 102, and the second water inlet 102 is connected to the hose 4.

Finally, the second water outlet 102 is provided with a thread, and the second water inlet 102 is connected to the hose 4 with the thread.

### Embodyment 2

As shown in FIG. 1 and FIG. 2, the present invention provides a shower device having a shower head fixing structure, which is used for fixedly connecting the shower head 1 to the water passing member 2.

The shower head fixing structure includes the fixing male member 201 and the fixing female member 101. The fixing male member 201 is disposed at one end of the water passing member 2. The fixing female member 101 is disposed on a side opposite to the water outlet side of the shower head 1, and the fixing opening 1011 for receiving the fixing male member 201 is formed between the fixing female member 101 and the shower head 1.

Next, the fixing male member 201 is an elliptical plate (not shown). And, this elliptical plate can be easily made by a person ordinarily skilled in the art based on the circular plate.

Next, one side of the fixing male member 201 in contact with the shower head 1 is a flat surface. An edge of the fixing male member 201 is convex for linking with the fixing female member 101.

Next, the fixing male member 201 is attached to one end of the water passing member 2.

Next, one end surface of the fixing female member 101 is semi-elliptical (not shown). And, this semi-elliptical shape can be easily made by a person ordinarily skilled in the art based on the semicircular shape.

Next, the outlet of the shower head 1 is front, then the opposite part is the backside. The fixing female member 101 is disposed on an upper portion of the backside of the shower head 1.

Next, the fixing opening 1011 is disposed on the fixing female member 101, and the fixing opening 1011 is semicircular. The fixing opening 1011 is fitted to the end surface of the water passing member 2.

Next, the fixing female member 101 is attached to an upper portion of the backside of the shower head 1.

The present invention provides the shower device having a shower head fixing structure, that includes a shower head 1, the water passing member 2, the water inlet arm 3, the hose 4 the fixing female member 101, and the fixing male member 201. One end of the water inlet arm 3 is connected to the water passing member 2. One end of the hose 4 is connected to the water passing member 2, and the other end of the hose 4 is connected to the shower head 1.

And, the water passing member 2 includes the first water inlet 202 and the first water outlet 203. The first water inlet 202 is connected to one end of the water inlet arm 3, and the first water outlet 203 is connected to the hose 4.

Then, the first water inlet 202 is provided with a thread, and the first water outlet 203 is provided with a thread. The first water inlet 202 is connected to the water inlet arm 3 with the thread, and the first water outlet 203 is connected to the hose 4 with the thread.

Next, one end of the shower head 1 is provided with the second water inlet 102, and the second water inlet 102 is connected to the hose 4.

Finally, the second water outlet 102 is provided with a thread, and the second water inlet 102 is connected to the hose 4 with the thread.

The above is only the preferred embodiment of the present invention, and it is of course not possible to limit the scope of the present invention. Accordingly, equivalent changes made in the claims of the invention are still within the scope of the invention.

What is claimed is:

1. A shower device, comprising:
a shower head fixing structure for fixing a shower head to a water passing member;
a water inlet arm, connected to the water passing member; and
a hose, one end of the hose connected to the water passing member and the other end of the hose connected to the shower head.

2. The shower device as claimed in claim 1, wherein the water passing member includes a first water inlet connected to one end of the water inlet arm as well as a first water outlet connected to the hose.

3. The shower device as claimed in claim 1, wherein one end of the shower head is provided with the second water inlet, and the second water inlet is connected to the hose.

4. The shower device as claimed in claim 1, wherein the shower head fixing structure used for fixing the shower head to the water passing member includes:
a fixing male member, disposed at one end of the water passing member; and
a fixing female member, disposed on a side opposite to the water outlet side of the shower head, wherein a fixing opening for receiving the fixing male member is formed between the fixing female member and the shower head.

5. The shower device as claimed in claim 4, wherein the fixing male member is integrally formed with the water passing member.

6. The shower device as claimed in claim 4, wherein the fixing female member is integrally formed with the shower head.

7. The shower device as claimed in claim 4, wherein the fixing male member is a circular plate.

8. The shower device as claimed in claim 7, wherein one side of the fixing male member in contact with the shower head is a flat surface and an edge of the fixing male member is convex for linking with the fixing female member.

9. The shower device as claimed in claim 4, wherein one end surface of the fixing female member is semicircular.

10. The shower device as claimed in claim 9, wherein the fixing opening is disposed on the fixing female member, and the fixing opening is fitted to the end surface of the water passing member.
